(19) United States
(12) Patent Application Publication
(10) Pub. No.: US 2026/0237541 A1
(43) Pub. Date: Aug. 13, 2026

(54) DATA-TRANSMISSION CABLE AND METHOD FOR PRODUCING A SHIELDED DATA-TRANSMISSION CABLE

(71) Applicant: BIZLINK INDUSTRY GERMANY GMBH, ROTH (DE)

(72) Inventors: BENJAMIN KIESSLING, STEIN (DE); HANS WOLFSBERGER, ROTH (DE); JOHANNES HALLMEYER, ABENBERG (DE); PETER LEHMANN, ABSBERG (DE)

(73) Assignee: BIZLINK INDUSTRY GERMANY GMBH, ROTH (DE)

(21) Appl. No.: 19/153,610

(22) PCT Filed: Feb. 5, 2024
(86) PCT No.: PCT/DE2024/035008

§ 371 Date: Aug. 5, 2025

(30) Foreign Application Priority Data
Feb. 15, 2023 (DE) 10 2023 103 716.1

(51) Int. Cl. H01B 11/18; H01B 1/02; H01B 11/02; H01B 13/22

(52) U.S. Cl. CPC H01B 11/1895; H01B 1/026; H01B 11/02; H01B 13/22

(57) ABSTRACT

A data-transmission cable includes a cable sheath having an inner lateral surface, at least one pair of wires having a first conductor and a second conductor, a first shielding which surrounds the at least one pair of wires over a longitudinal extent thereof to provide a sheathed at least one pair of wires, and a second shielding arranged inside the cable sheath.

The first shielding has a first shielding film, a first braid which encloses the first shielding film, and a second shielding film which encloses the first braid. The second shielding encloses the sheathed at least one pair of wires. The second shielding has a second braid arranged indirectly or directly on the inner lateral surface of the cable sheath. Each of the sheathed at least one pair of wires is enclosed by the cable sheath. The first shielding film and/or the second shielding film is a lubricated film.

### CROSS REFERENCE TO PRIOR APPLICATIONS

This application is a U.S. National Phase application under 35 U.S.C. § 371 of International Application No. PCT/DE2024/035008, filed on Feb. 5, 2024 and which claims benefit to German Patent Application No. 10 2023 103 716.1, filed on Feb. 15, 2023. The International Application was published in German on Aug. 22, 2024 as WO 2024/170025 A1 under PCT Article 21(2).

### FIELD

The present invention relates to a data-transmission cable and to a method for producing a shielded data-transmission cable.

### BACKGROUND

Data cables (data-transmission cables, UTP, STP, cables, Internet cables, Ethernet cables, LAN cables or twisted pair cables) are in general cables that are intended for the transmission of data.

A data cable in particular comprises at least two conductors (wires), or an inner conductor and an outer conductor, or a conductor bundle having a plurality of wires and a cable sheath, and can furthermore comprise filler material, separating elements and/or shieldings.

A wire is in particular a plastics-insulated copper conductor. A wire typically has a diameter of 0.9 mm or 1.1 mm. A wire and/or a plurality of wires can be surrounded by an electrically conductive shield. The shield can typically comprise a metal film (e.g., aluminum film), a metallized plastics film, a wire braid, or combinations thereof. The shield in particular serves to reduce the influence of an outside electromagnetic field, and thereby, for example, to reduce interactions with electromagnetic fields induced by devices or cables. The shield can furthermore reduce or prevent interference radiation. According to ISO/IEC 11801, U stands for an unshielded cable, wherein in this case a reduction of outside influences is achieved via symmetry, F stands for film shielding, S for braided shielding, and SF for braid and film shielding.

The cable sheath material is frequently PVC, polyurethane, polyethylene, or other halogen-free and flame-resistant polymer mixtures.

The filler material can in particular comprise a plastics material and in particular fills cavities between a plurality of wires or pairs of wires.

Data cables are in particular used for the installation of telephone and computer networks or in fieldbus technology, and represent a connecting conductor or partial conductor between devices. The connection of the devices via a data cable is usually configured as a physical plug connection. A plug (e.g., a RJ45 plug) is thus usually arranged at both ends of a data cable for connection purposes, i.e., a data cable allows communication between electrical devices.

Various data cable designs are known from the prior art which are designed for use for specific application cases or at specific application sites, for example, for short or long distances, particularly space-saving, highly flexible, or particularly water-protected.

Data cables are known which comprise twisted pairs of wires. It is known that twisted pairs of wires offer better electromagnetic protection from interfering fields than wires that are guided in parallel. Twisted pairs of wires serve in particular for symmetrical signal transmission. The pairs of wires usually have a standardized color coding (in particular grey, orange, blue, black). Ethernet cables with four wires in particular have the color coding white, blue, yellow and orange. Ethernet cables with eight wires in particular have the color coding white/green, green, orange-white, orange, white/blue, blue and white-brown, brown.

Data cables are known which comprise a plurality of twisted pairs of wires which are stranded together in data cables.

Data cables are furthermore categorized according to their power. The power refers to a transmission path, the conduction, the plug and further network components, and is defined according to ISO/IEC 11801 or EN 50173. Data cables of category 7 (Class F) allow for operating frequencies of up to 600 MHz, and category 7A (Class FA) of up to 1000 MHz. What are known as Cat7 cables in this case comprise four individually shielded pairs of wires which are arranged within a common shield.

Data cables are known for a permanently moving use (e.g., in cable carriers, etc.) in which the data cable must also withstand tight and changing bending radii, the wires of which comprise a shielding via a film and a braid over the film. In the case of such data cables for a permanently moving use, the shielded pairs of wires are furthermore typically covered in each case with an extruded insulation so that the shielded pairs of wires are not in contact with the shield close to the cable sheath, which is usually configured as a braid. The decoupling serves to prevent a movement-induced friction between the shields close to the wires, and between these and the shield close to the cable sheath, and associated damage to the shieldings. Such a known structure of data cables for a permanently moving use is associated with a high manufacturing outlay during finishing. Such data cables furthermore have a large diameter.

DE 10 2012 024 386 A1 describes a cable for transmitting signals, the cable comprising a plurality of wires, on the inner conductors of which an electrically conductive end piece is fastened.

DE 10 2015 216 470 A1 describes a cable, in particular a data-transmission cable, comprising at least one wire, having an inner conductor and a wire sheathing which is applied directly thereto and which comprises a dielectric layer of a foamed, non-crosslinked thermoplastic, for example, polyethylene or polypropylene, wherein an outer skin layer of unfoamed, chemically crosslinked polyethylene is arranged around the dielectric layer.

DE 10 2017 210 096 A1 describes a data cable which comprises at least one pair of wires and a cable sheath that surrounds the at least one pair of wires. The at least one pair of wires comprises two wires that are stranded together in the longitudinal direction of the data cable. Cavities that exist between the at least one pair of wires and the cable sheath are filled at least in part with a filler material. The filler material has a viscosity so as to adhere in the data cable so that the filler material remains at least almost completely in the data cable in the case of a predetermined pressure difference between one end of the data cable and another end of the data cable.

DE 10 2016 209 138 B4 describes a data cable comprising at least one pair of wires having two wires extending in parallel in the longitudinal direction of the data cable, and an inner element having at least one flat portion, wherein the at least one pair of wires rests on the at least one flat portion of the inner element, wherein the inner element comprises at least one wire for data transmission at low data rates, wherein the at least one wire for the data transmission at low data rates is arranged in each case on a short side of the inner element and is integrated into the inner element.

DE 10 2023 106 767 A1 describes a shielded twisted pair cable comprising a twisted pair wire that contains two insulated wires that are twisted together, and a shielding which is configured to cover the twisted pair wire. Each of the two insulated wires contains a conductor and an insulator that covers the conductor. The shielding contains a first shielding, a second shielding, and a third shielding, in this order, proceeding from a position which is closest to the twisted pair wire. The first shielding contains a resin band with a metal film which is wound in a helical manner around the twisted pair wire, the second shielding contains a braided conductor, and the third shielding contains a second resin band with a metal film. The metal film of the first resin band with the metal film is in contact with the braided conductor, and the braided conductor is in contact with the metal film of the second resin band with the metal film.

DE 25 47 152 A1 describes an electrical shielding of cables and lines using conductive films, wherein the shielding consists of conductively adjusted plastics films.

DE 10 2016 221 661 A1 describes a data cable comprising a core and a shielding surrounding the core, which comprises a first shielding layer having a plurality of individual shielding wires, wherein some of the shielding wires are replaced by at least one transmission element.

DE 103 15 609 A1 describes a data-transmission cable which consists of at least two wires that are stranded together, each of which comprises a conductor surrounded by an insulation. The two wires are surrounded by a common electrical shield. The two wires comprise a solid, unfoamed insulation, and are stranded together with two strands consisting of foamed insulating material to form a core. The core is surrounded by a film consisting of foamed insulating material, and an electrically conductive plastics fleece, which is formed into a tubularly closed sleeve, is formed around the film, which plastics fleece is coated in a penetrating manner with a highly electrically conductive metal which is applied on and in the plastics fleece via vapor phase deposition.

CN 2 12 062 012 U describes a 5G data cable for an underwater robot. The data cable comprises a cable core which surrounds a power cable, a local network signal cable, the 5G communication cable, and a filler. The sheathing layer comprises an LDPTFE film and an EMI-transparent electromagnetic shielding film and covers the outside of the cable core. The overall woven layer is mixed and woven from fine carbon fiber filaments and Kevlar-aramid yarn and is applied to the outside of the entire winding strip layer. A central protective layer consists of HDPE material. The outer sheathing is arranged on the outside of the entire woven layer, wherein the outer shell comprises the modified PUR material and surrounds the outside of the layer in a protective manner.

There is consequently a need for a data-transmission cable which is suitable for a permanently moving use which in the process implements a reliable shielding and which has a reduced production outlay and a smaller diameter.

### SUMMARY

An aspect of the present invention is to improve upon the prior art.

In an embodiment, the present invention provides a data-transmission cable which includes a cable sheath comprising an inner lateral surface, at least one pair of wires comprising a first conductor and a second conductor, a first shielding which is configured to surround one of the at least one pair of wires over a longitudinal extent of the at least one pair of wires so as to provide a sheathed at least one pair of wires, and a second shielding which is arranged inside the cable sheath. The first shielding comprises a first shielding film, a first braid which is configured to enclose the first shielding film, and a second shielding film which is configured to enclose the first braid. The second shielding is configured to enclose the sheathed at least one pair of wires. The second shielding comprises a second braid which is arranged indirectly or directly on the inner lateral surface of the cable sheath. Each of the sheathed at least one pair of wires is enclosed by the cable sheath. At least one of the first shielding film and the second shielding film is a lubricated film.

### BRIEF DESCRIPTION OF THE DRAWINGS

The present invention is described in greater detail below on the basis of embodiments and of the drawings in which:

FIG. 1 is a schematic view of a cross-section of a data-transmission cable according to the present invention; and

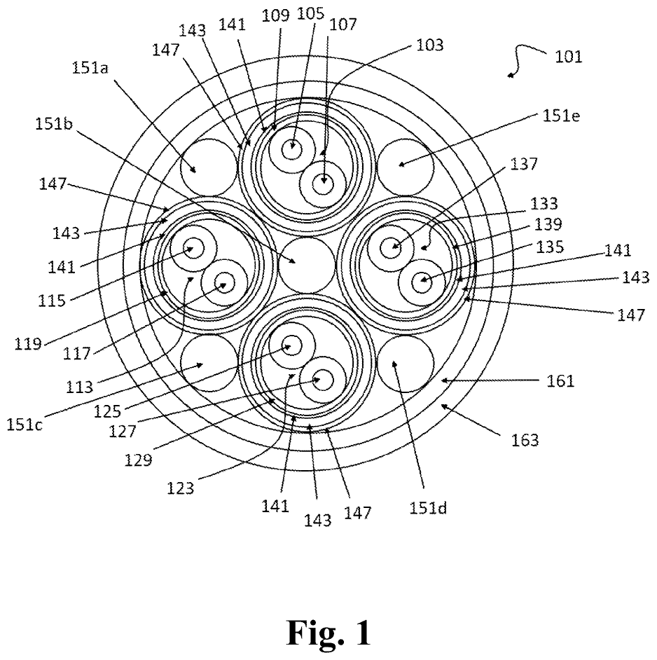

FIG. 2 shows method steps of a method according to the present invention for producing a data-transmission cable according to the present invention.

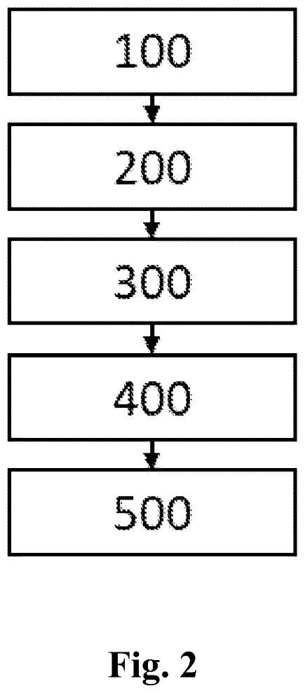

### DETAILED DESCRIPTION

The present invention provides a data-transmission cable comprising a cable sheath, which in particular comprises a thermoplastic polymer, and at least one pair of wires, wherein the at least one pair of wires comprises a first conductor and a second conductor, as well as a first shielding, surrounding the at least one pair of wires over its longitudinal extent, wherein the first shielding comprises a first shielding film and a first braid, enclosing the first shielding film, and a second shielding film, enclosing the first braid, wherein the at least one pair of wires is present enclosed by the cable sheath, wherein furthermore a second shielding is present inside the cable sheath, which encloses the sheathed at least one pair of wires, wherein the second shielding comprises a second braid and is arranged indirectly or directly on an inner lateral surface of the cable sheath, and wherein the first shielding film and/or the second shielding film is a lubricated film.

A data-transmission cable is thus provided which is suitable for a permanently moving use which in the process implements contact among the shieldings and in particular provides a very high degree of and a very reliable shielding via the first shielding and the second shielding. The first shielding is implemented as a 3-fold shielding having the structure first shielding film, braid, second shielding film, wherein both shielding films or one of the shielding films is/are lubricated. The first shielding, which is also referred to as first shield, in this case surrounds the wire to be shielded and/or the pair of wires along its longitudinal extent.

In the prior art, the friction among the braids could lead to damage to the respective braids of the pairs of wires and to the braid of the overall shielding. A reduced shielding effect is associated therewith. In particular in order to avoid this disadvantageous effect, the second shielding film is provided on the at least one pair of wires. This sheaths the braid of the first shielding of the at least one pair of wires, and can thereby prevent friction between the first braid and the second braid and/or optionally between first braids of further pairs of wires. The first and/or second shielding film is advantageously lubricated therefor, in particular additionally made slidable and/or provided with a slip agent, in order to even further reduce friction. The same applies for a second, third and/or fourth pair of wires, and/or for further braids. The first braids protect the inner first shielding film of the pair of wires in particular from damage, for example, breakage, above all in the case of continuous movements. The first braids of the pairs of wires would furthermore continue to maintain a shielding even if a breakage of the first shielding film of the wires of the pair of wires occurs. The shielding is in particular achieved by a connection of the fragments of the possibly broken first shielding film by the respective first braid. The structure of the shielding thus advantageously implements a good and reliable shielding in a permanently moving use of the data cable.

The configuration of the first shielding film and/or the second shielding film as a lubricated film advantageously improves a sliding of the shielding films on contact surfaces or elements so that the likelihood of damage, in particular by frictional contact of the film and/or the elements which cover the film, is reduced. Surfaces of elements or elements that are arranged inside the cable sheath are in particular understood as contact surfaces or contact elements.

The data-transmission cable according to the present invention advantageously has a significantly smaller cross-section than known solutions for data-transmission cables for a permanently moving use since no extruded insulation is required.

The data-transmission cable according to the present invention is furthermore advantageously easier to finish than known solutions for data-transmission cables for a permanently moving use, and thus has a reduced manufacturing outlay.

It was surprisingly found that the data-transmission cable according to the present invention has an improved shielding than known solutions, and is thus also of interest for other fields of use, such as for cable carriers, doors, couplings, bogies, etc., and for permanently moving fields of use.

A concept of the present invention is based on protecting the inner shielding of a pair of wires of a data-transmission cable even in the case of a permanently moving use and frictional contact with other cable elements so as to provide a reliable shielding.

The following is explained regarding terms:

A “data-transmission cable”, also referred to as a data cable, twisted pair cable, or Ethernet cable, is in particular understood to be a cable which is configured for transmitting data and/or power. The data-transmission cable is in particular cylindrical and has a longitudinal extent and a predefined cross-section. The data-transmission cable can additionally or alternatively be square, rectangular or oval. The data-transmission cable can also be flat.

At 20° C., the data-transmission cable according to the present invention in particular has a resistance of at most 290 Ohm/km, a resistance difference of 2 %, an insulation resistance of at least 500 MOhm*km, a time delay of at most 5.3 ns/m, a time delay (conductor to conductor in the same pair) of at most 0.25 ns/m, a capacitance (asymmetrical) of at most 1600 pF/km, a coupling damping (30-100 MHz) of at least 80 dB, and/or a shielding damping (30-600 MHz) of at least 55 dB. The data-transmission cable according to the present invention furthermore in particular has an operating voltage (peak) of at least 300 V, a characteristic impedance (100 MHz) of (100±5) Ohms, and a test voltage (wire/wire/shield rms 50 Hz 1 min) of 1000 V. The transmission quality of the data cable according to the present invention is thus advantageously high, with a simultaneously high shielding.

The data cable according to the present invention can, for example, have a minimum bending radius in the magnitude of 10 times, in particular 7.5 times, the diameter of the data cable for the permanently moving use, and in the magnitude of 5 times, in particular 3 times, the diameter of the data cable in the case of one-time bending. The data cable can thus advantageously withstand a high frequent bending load undamaged. The data-transmission cable advantageously has a cable sheath and at least one first wire or one first pair of wires. The data-transmission cable can additionally or alternatively have a second pair of wires and/or a further pairs of wires. The same embodiment possibilities and advantages apply as described below for further pairs of wires. A higher transmission rate can be implemented via further pairs of wires.

A “pair of wires” is in particular understood to mean two wires, also referred to as a conductor or a twisted pair wire. A wire is in particular a physical transmission medium for transmitting data, in particular for transmitting data between a transmitter and a receiver. A pair of wires can in particular be twisted.

A wire in particular comprises a copper wire as a strand or a plurality of copper wires as strands, and is provided so as to be plastics-insulated. The plastics insulation in particular comprises polyethylene (PE). The longitudinal extent of a wire can, for example, be significantly larger than the transverse extent of the wire. In one possible embodiment, a wire has a diameter of 0.9 mm to 1.1 mm. The strand can, for example, have a diameter of 0.4 mm to 0.55 mm, in particular of 0.47 mm. The strand can be configured as an AWG 24 or as an AWG 26 strand. The strand can additionally or alternatively comprise silvered copper.

In an embodiment, a wire comprises copper, a copper alloy, and/or silvered copper. A wire can additionally or alternatively comprise pure copper. Finally, a wire can additionally or alternatively comprise tinned copper.

The wire and/or the pair of wires of the data-transmission cable can be provided according to a predefined finish, arranged in the cable sheath. The finish advantageously implements the transmission requirements that are placed on the data cable.

In an embodiment, the finish comprises a data-transmission cable having a plurality of, in particular four, twisted pairs of wires. The twisted pairs of wires can additionally or alternatively be provided stranded together and/or be stranded using further elements.

Stranding can advantageously lead to improved stability and/or implement flexibility and/or mobility of the data cable along its longitudinal extent.

The finish can additionally or alternatively comprise a filler material. The filler material in particular comprises plastics material and can, for example, fill cavities between the wires of pairs of wires, so that advantageously a respective predefined location, also referred to as a position, or guide of the wires and/or pairs of wires emerges. The predefined location is in particular based on a specific spacing from a starting point and can repeat along the longitudinal extent of the data cable. A separating element or separating elements can in addition or alternatively be used for positioning the wires and/or pairs of wires. Filler material, separating elements, and further elements, which serve for arranging the wires and/or pairs of wires, are referred to below as auxiliary elements. A more stable obtaining of a predefined finish of the data cable elements over the longitudinal extent of the data cable can be implemented using auxiliary elements.

A data-transmission direction can additionally or alternatively be defined per wire and/or per pair of wires. The data-transmission direction can in particular be transmitting and/or receiving, proceeding from a device connected to the data-transmission cable. The definition of a data-transmission direction advantageously leads to a direction-bound adjustability of the specific parameterization of the data cable. In order to preserve the specific parameterization, uniquely assignable plug elements can be used, which can advantageously be connected to a respective electrical device only in one way.

A “cable sheath” is in particular understood to be an outer shell of the wire and/or pairs of wires and/or of auxiliary elements. The cable sheath in particular comprises a thermoplastic material, which can additionally or alternatively be crosslinked. The cable sheath can in particular comprise a thermoplastic polymer. The thermoplastic polymer can comprise polyvinyl chloride (PVC), polyethylene (PE), polyamide (PA), and/or polyurethane (PUR). The cable sheath can comprise a flame-retardant and/or a non-corrosive material (FRNC). The cable sheath is additionally or alternatively configured in accordance with DIN EN 50290-2-27 (HD 624.7). The cable sheath in particular has an outer lateral surface and an inner lateral surface, and is in particular hollow-cylindrical. The cable sheath around the wires and/or pairs of wires can additionally or alternatively be moldable and curing, or can comprise a slot for insertion of the wires and/or pairs of wires. The cable sheath advantageously implements protection of the wires and/or the pairs of wires and/or the auxiliary elements against environmental influences, in particular against dirt, aerosols, and moisture.

In an embodiment of the data-transmission cable, the outside diameter of the cable sheath according to the present invention is 8 mm to 10 mm, in particular 8.2 mm to 9.1 mm, in particular 8.7 mm, very particularly 8.2 mm.

Electric and magnetic fields (electromagnetic fields) in particular describe a spatial distribution of actions of force on electric charges and currents. Such fields can in particular be generated artificially or appear naturally. Artificially generated electromagnetic fields can, for example, be induced by electrically operated devices or also other cables. An outside action of force of an electromagnetic field on the wire and/or the pair of wires in particular reduces a power of the data-transmission task. In order to reduce the influence of outside electromagnetic fields on the data-transmission cable, what is known as “shielding” is carried out.

“Shielding” is in particular understood to be a protection of the data transmission via the wire and/or the pair of wires against an outside electric and/or magnetic field, shielding of the wires of a pair of wires, pairs of wires from one another, and/or the protection of the environment against an electromagnetic field of the wire or pair of wires. The shielding according to the present invention in particular comprises a first shielding and a second shielding. The first shielding is in particular implemented in a manner surrounding the respective pair of wires, and the second shielding is in particular implemented surrounding all the pairs of wires arranged in the cable sheath. The shielding is in particular configured in accordance with DIN EN 50290-2-23 (VDE 0819), table 2/A (HD 624.3) (02Y).

A shielding in this case surrounds the wire to be shielded and/or the pair of wires along its longitudinal extent. In other words, in the case of a hollow-cylindrical data cable, the shielding can, for example, also have a hollow-cylindrical profile. At least one further layer can additionally or alternatively be provided which surrounds the second shielding film. The at least one further layer can alternatively or optionally additionally be arranged between the first shielding film and the first braid, between the first braid and the second shielding film, and/or between the pair of wires and the first shielding film. The first shielding can additionally or alternatively comprise at least one further layer which can in particular improve the shielding and/or provide an improved securing of the shielding in the case of a permanently moving use of the data cable. The at least one further layer can in particular be configured as an insulating layer, a separating layer, a connecting layer, a adhesive layer, a sliding layer, or in a manner substantially similar to the first and/or second shielding film and/or to the braid. In the context of the present invention, it is alternatively or additionally possible for the second braid to be provided, in particular surrounded or wound with, a banding, for example, of glass fiber or fleece.

A “shielding film” is in particular understood to be a substantially thin film which surrounds a wire and/or a pair of wires along its longitudinal extent and is designed for shielding an outside electromagnetic field. A shielding film can in particular be a shielding or a layer of a plurality of layers of a shielding. The shielding film surrounds the wire to be shielded and/or the pair of wires or a further layer of a shielding along the longitudinal extent of the wire and/or the pair of wires, and thus, in the case of a hollow-cylindrical data cable, substantially also has a hollow-cylindrical profile.

In an embodiment, the first shielding film and/or the second shielding film can in particular comprise aluminum. The first shielding film and/or the second shielding film can additionally or alternatively comprise a plastics material via which an improved stability and/or an improved protection is advantageously implemented. The first shielding film and/or the second shielding film can finally be a lubricated film. The lubricated film can in particular comprise polyethylene, polypropylene and/or polyethylene terephthalate. The first shielding film and the second shielding film can therefore comprise the same material.

A “lubricated shielding film”, which means a lubricated first shielding film and/or a lubricated second shielding, is in particular understood to be a shielding film of which the glide is increased via a surface treatment, in particular using a slip agent, in particular a lubricating agent. In an embodiment, the shielding film can be lubricated via Lubrizol® and/or an oil, fat or the like. A lubricated film advantageously has an improved glide compared with surrounding elements that contact it. A likelihood of damage to the shielding(s) during a movement of the data cable and/or a relative movement of the shielding elements can therefore be reduced.

The shielding film can have a thickness of 0.05 mm to 0.08 mm. A transparent sliding film of polypropylene can additionally or alternatively be arranged between the first shielding film and the wire. The sliding film in particular has a thickness of from 0.01 mm to 0.02 mm.

The second shielding film can have a thickness of from 0.01 mm to 0.05 mm, in particular of 0.03 mm.

A “first braid” is in particular understood to be an entwined and/or woven mesh of strands. The first braid can be configured as a shielding braid and/or stranding of an electrically conductive material and/or wire. The first braid can, for example, comprise copper, in particular copper wire. The first braid can finally comprise tinned copper wire, a plastics material, and/or tinned copper. The thickness of the first braid can be 0.05 mm to 0.15 mm, in particular 0.06 mm to 0.09 mm. A first braid is in particular a first shielding of a wire and/or a pair of wires, or at least one layer of a first shielding of the wire and/or a pair of wires. The first braid surrounds the wire to be shielded and/or the pair of wires or a further layer of a shielding, along the longitudinal extent of the wire and/or of the pair of wires, and therefore, in the case of a hollow-cylindrical data cable, has a substantially hollow-cylindrical profile. The first braid in particular surrounds the at least one pair of wires, and the first shielding film is surrounded by at least the second shielding film, the second braid and/or the cable sheath, and thereby advantageously implements a stabilization and a protection of the shielding films and shielding of the wire and/or of the pair of wires.

The “second shielding” is in particular arranged on the inner lateral surface of the cable sheath. A further layer, in particular a separating layer, a connecting layer, an insulating layer and/or an adhesive layer can be arranged between the cable sheath and the second shielding. The second shielding advantageously implements an additional shielding which surrounds the wires, the at least one pair of wires and/or the pairs of wires that are in each case shielded via the first shielding. The second shielding can in particular be configured as a second braid.

A “second braid” is in particular understood to be an entwined and/or woven mesh of strands, which is in particular arranged indirectly or directly on the inner lateral surface of the cable sheath and/or surrounds all the pairs of wires, overall, arranged in the cable sheath. The second shielding and/or the second braid can in particular be referred to as an overall shielding for a plurality of, for example, twisted or stranded together, pairs of wires.

The second braid can comprise metal. The second braid can additionally or alternatively comprise a plastics material. The second braid can finally comprise one and/or more layers. The second braid can be configured in the same way as the first braid. In order to avoid repetition, reference is here made to the statements regarding the first braid above.

Measurements have shown that the shielding according to the present invention, via the braid, achieves a degree of shielding of approximately 90 %. According to measurements, the shielding according to the present invention, consisting of film shields and braids, can, for example, implement an overall degree of shielding of substantially or approximately 100 % against an outside electromagnetic field. It has been shown that the shielding of the data-transmission cable according to the present invention has, at 1 MHz, a transfer impedance of less than 15 mOhm/m, at 10 MHz, a transfer impedance of less than 10 mOhm/m, and at 30 MHz, a transfer impedance of less than 30 mOhm/m.

The present invention also provides a method for producing a shielded data-transmission cable.

In a first step of the method, at least one twisted pair of wires, one first shielding film, one first braid, and one second shielding film, is provided. The first and/or the second shielding film is/are in particular lubricated.

In a second step, the at least one twisted pair of wires is sheathed with the first shielding film, and subsequently with the first braid, and subsequently with the second shielding film, so that at least one shielded twisted pair of wires is present.

In an optional intermediate step, which in particular takes place between the second and a fourth step, a plurality of, in particular at least two, shielded twisted pairs of wires are stranded together, so that a stranded arrangement results. Optionally, in the context of the intermediate step, in addition a filler can be provided, which filler is stranded together with the plurality of shielded twisted pairs of wires, so that a stranded arrangement of a plurality of twisted pairs of wires and the filler is present.

In a fourth step, a second braid is provided and the at least one shielded twisted pair of wires or the stranded arrangement is sheathed with the second braid, so that a shielded overall arrangement is present.

In a fifth step, a cable sheath material is provided, and the shielded overall arrangement is sheathed with the cable sheath material, so that a shielded data-transmission cable is present.

In order to avoid repetitions, reference is made at this point to the statements regarding the first aspect, which apply analogously.

The present invention is explained in greater detail below with reference to embodiments as shown in the drawings.

The data cable 101 comprises four pairs of wires 103, 113, 123, 133. The first pair of wires 103 comprises a first plastics-sheathed silvered copper strand 105 and a second plastics-sheathed silvered copper strand 107, wherein the first plastics-sheathed silvered copper strand 105 and the second plastics-sheathed silvered copper strand 107 are twisted together and sheathed by a first polyethylene banding 109. The second pair of wires 113 comprises a third plastics-sheathed silvered copper strand 115 and a fourth plastics-sheathed silvered copper strand 117, wherein the third plastics-sheathed silvered copper strand 115 and the fourth plastics-sheathed silvered copper strand 117 are twisted together and sheathed by a second polyethylene banding 119. The third pair of wires 123 comprises a fifth plastics-sheathed silvered copper strand 125 and a sixth plastics-sheathed silvered copper strand 127, wherein the fifth plastics-sheathed silvered copper strand 125 and the sixth plastics-sheathed silvered copper strand 127 are twisted together and sheathed by a third polyethylene banding 129. The fourth pair of wires 133 comprises a seventh plastics-sheathed silvered copper strand 135 and an eighth plastics-sheathed silvered copper strand 137, wherein the seventh plastics-sheathed silvered copper strand 135 and the eighth plastics-sheathed silvered copper strand 137 are twisted together and sheathed by a fourth polyethylene banding 319. The copper strands 105, 107, 115, 117, 125, 127, 135, 137 each have a diameter of 0.49 mm. The polyethylene bandings 109, 119, 129, 139 each have a diameter of 1 mm. The first pair of wires 103 and the second pair of wires 113 and the third pair of wires 123 and the fourth pair of wires 133 is in each case sheathed with a first lubricated aluminum film 141, as an embodiment of a first shielding film, and a first tinned copper wire braid 143, as an embodiment of a first braid, and a second lubricated aluminum film 147, as an embodiment of a second shielding film. The data cable 101 furthermore comprises a first filler 151a, a second filler 151b, a third filler 151c, a fourth filler 151d, and a fifth filler 151e. The fillers 151a, 151b, 151c, 151d, 151e have a diameter of 0.4 m-0.5 mm. The sheathed pairs of wires 103, 113, 123, 133 and the fillers 151a, 151b, 151c, 151d, 151e are stranded together, wherein the fillers 151a, 151b, 151c, 151d, 151e are arranged between the pairs of wires 103, 113, 123, 133 so that a predefined location of the pairs of wires 103, 113, 123, 133 relative to one another is provided. The arrangement of the stranded pairs of wires 103, 113, 123, 133 and fillers 151a, 151b, 151c, 151d, 151e is sheathed by a second tinned copper wire braid 161. Finally, the data label 101 is sheathed outermost by a thermoplastic copolymer sheath 163.

In a first step 100 of the method for producing a data cable 101, a twisted first pair of wires 103, a twisted second pair of wires 113, a twisted third pair of wires 123 and a twisted fourth pair of wires 133, as well as a first lubricated aluminum film 141, a first tinned copper wire braid 143, and a second lubricated aluminum film 147, are provided.

In a second step 200, the twisted pairs of wires 103, 113, 123, 133 are each sheathed with the first lubricated aluminum film 141, the first tinned copper wire braid 143, and the second lubricated aluminum film 147, so that four shielded pairs of wires 103, 113, 123, 133 are present.

In a third step 300, the four shielded pairs of wires 103, 113, 123, 133 and five fillers 151a, 151b, 151c, 151d, 151e are stranded together and arranged so that a stranded arrangement of the shielded pairs of wires 103, 113, 123, 133 and the fillers 151a, 151b, 151c, 151d, 151e is present.

In a fourth step 400, a second tinned copper wire braid 161 is provided and the arrangement is sheathed with the second tinned copper wire braid 161, so that a shielded arrangement of the shielded pairs of wires 103, 113, 123, 133 and the fillers 151a, 151b, 151c, 151d, 151e is present.

In a fifth step 500, a thermoplastic copolymer sheath 163 is produced, which sheaths the shielded arrangement of the shielded pairs of wires 103, 113, 123, 133 and the fillers 151a, 151b, 151c, 151d, 151e, so that a shielded data cable 101 is present.

In an alternative embodiment, the arrangement and the stranding of the fillers 151a, 151b, 151c, 151d, 151e with the pairs of wires 103, 113, 123, 133 can be omitted.

The present invention is not limited to embodiments described herein; reference should be had to the appended claims.

### LIST OF REFERENCE NUMERALS

101 data cable
103 first pair of wires
105 first plastics-sheathed silvered copper strand
107 second plastics-sheathed silvered copper strand
109 first polyethylene banding
113 second pair of wires
115 third plastics-sheathed silvered copper strand
117 fourth plastics-sheathed silvered copper strand
119 second polyethylene banding
123 third pair of wires
125 fifth plastics-sheathed silvered copper strand
127 sixth plastics-sheathed silvered copper strand
129 third polyethylene banding
133 fourth pair of wires
135 seventh plastics-sheathed silvered copper strand
137 eighth plastics-sheathed silvered copper strand
139 fourth polyethylene banding
141 first lubricated aluminum film
143 first tinned copper wire braid
147 second lubricated aluminum film
151a first filler
151b second filler
151c third filler
151d fourth filler
151e fifth filler
161 second tinned copper wire braid
163 thermoplastic copolymer sheath

What is claimed is:

1-10. (canceled)

11. A data-transmission cable comprising:
a cable sheath comprising an inner lateral surface;
at least one pair of wires comprising a first conductor and a second conductor;
a first shielding which is configured to surround one of the at least one pair of wires over a longitudinal extent of the at least one pair of wires so as to provide a sheathed at least one pair of wires, the first shielding comprising,
a first shielding film,
a first braid which is configured to enclose the first shielding film, and
a second shielding film which is configured to enclose the first braid; and
a second shielding which is arranged inside the cable sheath, the second shielding being configured to enclose the sheathed at least one pair of wires, the second shielding comprising a second braid which is arranged indirectly or directly on the inner lateral surface of the cable sheath,
wherein,
each of the sheathed at least one pair of wires is enclosed by the cable sheath, and at least one of the first shielding film and the second shielding film is a lubricated film.

12. The data-transmission cable as recited claim 11, wherein,
at least one of the first conductor and the second conductor has a diameter of 0.4 mm to 0.55 mm, and/or
at least one of the first conductor and the second conductor are twisted together.

13. The data-transmission cable as recited in claim 11, wherein at least one of the first shielding film and the second shielding film comprises at least one of aluminum and a plastics material.

14. The data-transmission cable as recited in claim 11, wherein at least one of the first conductor and the second conductor comprises at least one of copper and a copper alloy.

15. The data-transmission cable as recited in claim 11, wherein at least one of the first braid and the second braid comprises a copper wire.

16. The data-transmission cable as recited in claim 11, wherein the cable sheath has an outside diameter in a range of from 8 mm to 10 mm.

17. The data-transmission cable as recited in claim 11, wherein a transfer impedance of the first shielding at 1 MHz is <15 mOhm/m, at 10 MHz is <10 mOhm/m, and at 30 MHz is <30 mOhm/m.

18. A method for producing the data-transmission cable as recited in claim 11, the method comprising:
providing at least one twisted pair of wires, one first shielding film, one first braid, and one second shielding film;
sheathing the at least one twisted pair of wires with the first shielding film;
sheathing the at least one twisted pair of wires, sheathed with the first shielding film, with the first braid;
sheathing the at least one twisted pair of wires, sheathed with the first braid, with the second shielding film, so as to provide at least one shielded twisted pair of wires;
providing a second braid;
sheathing the at least one shielded twisted pair of wires with the second braid so as to provide a shielded overall arrangement;
providing a cable sheath material; and
sheathing the shielded overall arrangement with the cable sheath material so as to provide the data-transmission cable.

19. The method as recited in claim 18, further comprising:
providing at least two shielded twisted pairs of wires; and
stranding the at least two shielded twisted pairs of wires together to form a stranded arrangement,
wherein,
the stranded arrangement is sheathed with the second braid to form the shielded overall arrangement.

20. The method as recited in claim 18, further comprising:
providing at least two shielded twisted pairs of wires;
providing at least one filler; and
stranding the at least one filler and the at least two shielded twisted pairs of wires together to form a stranded arrangement,
wherein,
the stranded arrangement is sheathed with the second braid to form the shielded overall arrangement.
